(19) United States
(12) Patent Application Publication
(10) Pub. No.: US 2026/0065227 A1
(43) Pub. Date: Mar. 5, 2026

(54) METHOD AND SYSTEM FOR CENTRALIZED DATA MANAGEMENT AND TESTING

(71) Applicant: FastGrid LLC, Gilbert, AZ (US)

(72) Inventors: Peter Addy, Gilbert, AZ (US); Eric Curry, Gilbert, AZ (US); Gint Grabauskas, Gilbert, AZ (US)

(21) Appl. No.: 19/319,613

(22) Filed: Sep. 4, 2025

Related U.S. Application Data
(60) Provisional application No. 63/690,751, filed on Sep. 4, 2024.

(51) Int. Cl. G06Q 10/10

(52) U.S. Cl. CPC G06Q 10/103

(57) ABSTRACT

A method may include obtaining project information or data associated with a project. One or more variables associated with the project may be identified based on the project information. One or more studies applicable to the project may be selected based on the one or more variables. One or more models associated with the one or more studies may be run using the one or more variables. In some embodiments, a report including results of each study of the one or more studies based on the results of running the one or more models may be generated.

### CROSS-REFERENCE TO RELATED APPLICATIONS

This application claims the benefit of U.S. Provisional Application No. 63/690,751, filed on Sep. 4, 2024, the contents of which are hereby incorporated by reference in their entirety.

### FIELD

The embodiments discussed in the present disclosure are related to project management and testing.

### BACKGROUND

Engineering projects such as designing power grids, energy storages, among others require systematic testing processes to verify performance, reliability, and safety of the developed systems. As engineering projects are often designed to operate under varying and unpredictable conditions, controlled studies and tests are employed to validate design assumptions, identify potential weaknesses, and verify compliance with specifications. The testing processes may include or be guided by testing models. The testing models provide structured frameworks for evaluating system behavior under defined conditions. A testing model establishes the methodology, parameters, and expected outcomes against which the actual performance of a prototype or system can be compared.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method may include obtaining project information or data associated with a project. One or more variables associated with the project may be identified based on the project information. One or more studies applicable to the project may be selected based on the one or more variables. One or more models associated with the one or more studies may be run using the one or more variables. In some embodiments, a report including results of each study of the one or more studies based on the results of running the one or more models may be generated.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which.

FIG. 1 illustrates an example system configured for centralized data management and testing, in accordance with one or more embodiments of the present disclosure.

FIG. 2 a flowchart for a study testing method, in accordance with one or more embodiments of the present disclosure.

FIG. 3 illustrates an operating environment, in accordance with one or more embodiments of the present disclosure.

FIG. 4 illustrates a flowchart of an example method of centralized data management and testing, in accordance with one or more embodiments of the present disclosure.

FIG. 5 is an example computing system, in accordance with one or more embodiments of the present disclosure.

### DETAILED DESCRIPTION

An engineering project is a structured effort undertaken to design, develop, implement, and evaluate a technical solution to a problem. An engineering project may involve application of scientific principles, mathematical analysis, and/or engineering methods to create a system, process, or product that meet certain functional and/or performance requirements. Engineering projects, such as electrical, civil, structural, and/or Geotech projects are defined by objectives, resource, and time constraints. Engineering projects may be designed based on specific information and/or specifications. For example, the specifications may be determined such that purpose of the project may be met while optimizing available resources. Additionally, the specifications may be determined such that certain requirements such as governmental regulations, safety regulations, and/or industry standards are satisfied.

To test the specifications, one of more studies may be performed on the specifications. Each study of the one or more studies may study and/or analyze certain aspects of the projects. For example, the one or more studies may analyze the projects with respect to regulations and requirements. The studies may be performed using one or more models corresponding to the studies. Identifying the adequate studies and/or tests is critical in building a system that performs reliably, safely, and efficiently under intended conditions. Appropriate studies permit engineers to validate design assumptions, uncover weaknesses, and meet regulatory or industry standards. However, identifying the correct tests presents significant challenges. Projects include complex requirements, competing constraints, and uncertain operating environments, such that predicting which studies will yield the most relevant insights is challenging. Additionally, limitations in time, budget, or testing models may restrict the scope of evaluation.

An existing approach to identifying specific studies applicable to a particular project includes identifying the studies based on objectives, constraints, and/or risk associated with the particular project. For example, the particular project is analyzed to identify functional requirements and intended operating environment of the system. One or more aspects that are critical to validate through testing may be identified, and suitable testing models and methodologies are selected based on the one or more aspects. Such an approach helps select studies that are directly tied to project objectives. However, such an approach depends on individual judgements, which may introduce subjectivity and variability. Additionally, the approach may require extensive time and human resources.

Another existing approach may include building the one or more models based on the specifications and the corresponding studies. The models may be configured to analyze the specifications with respect to certain areas and to generate an output (e.g., a report) summarizing the results of the analysis. However, such an approach may be burdensome and time consuming. For example, building the models separately may take up time and may be difficult to keep track of. For instance, when a certain specification is updated (e.g., different parts, configurations, etc.), determining the models that are associated with the certain specification may need to be identified and updated. Such an approach may be time consuming and may cause errors in the studies.

According to one or more embodiments of the present disclosure, a system may provide a centralized platform in which information about a project may be gathered and applicable studies may be identified and performed with respect to the project. In particular, the applicable studies may be automatically selected based on the obtained information. One or more models corresponding to the applicable studies may be built and run to generate reports of the studies.

Embodiments of the present disclosure will be explained with reference to the accompanying drawings.

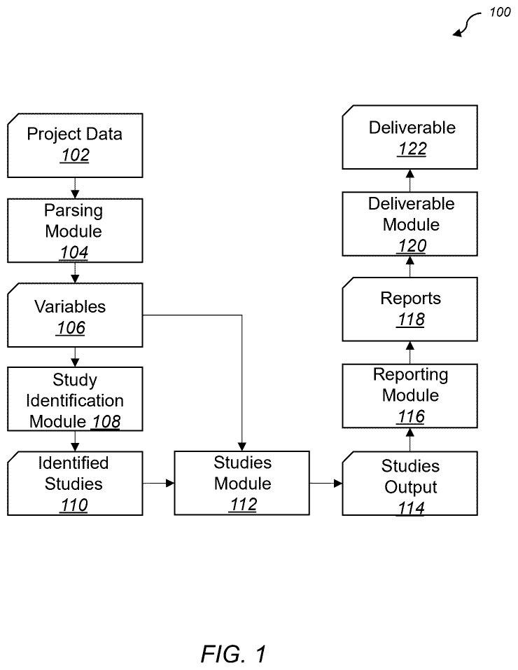

FIG. 1 illustrates an example system 100 configured for centralized data management and testing, in accordance with some embodiments of the present disclosure. In general, the system 100 may be configured to identify one or more studies appliable to a particular project based on project data 102. The system 100 may be configured to run the identified studies to generate a deliverable (e.g., deliverable 122). In the present disclosure, a reference to a study includes a reference to identifying, organizing, and documenting a set of tests relevant to a project. In some embodiments, the system 100 may be implemented with different types of projects, such as engineering projects, research and development projects, construction projects, manufacturing projects, etc. A project refers to a goal-oriented endeavor undertaken to create a product, service, or result.

In some embodiments, the system 100 may receive project data 102 from a user. The project data 102 may include specifications and/or details of a project. For example, the project may be related to setting up an engineering structure such as a powerplant. In such instances, the project data 102 may include information about the project such as location, size, duration, specific parts being used, performance requirements, among others. The project data 102 may include different formats and/or structures. For example, the project data 102 may include parts specifications from a manufacturer, an applicable safety standard, an engineering diagram, etc. Additionally, the project data 102 may include different levels of details. For example, the project data 102 may represent different stages of the project. For example, the project data 102 at the beginning of the project may include less information than the project data 102 toward the end of the project.

In some embodiments, the project data 102 may be stored in a file storage. The system 100 may be a centralized system including the file storage configured to store data. In some embodiments, the project data 102 may be stored such that the data may be shared, analyzed, and/or observed. For example, the system 100 may include search capabilities such that the project data may be searched.

The file storage may store project data, project testing data, and/or test reports. The system 100 may obtain initial project data 102 from a client. For example, the project may be related to setting up an engineering structure such as a powerplant. In such instances, the client may provide details of the project such as location, size, duration, specific parts being used, performance requirements, among others. Additionally, or alternatively, the system 100 may obtain any previous studies done by the client and/or the entity running the system 100.

In some embodiments, the parsing module 104 may be configured to identify variables 106 in the project data 102. The parsing module 104 may obtain and/or load the project data 102 from the file storage. The variables 106 may include features, attributes, descriptors, or other parts of the project data 102 that describe the data. In some embodiments, the parsing module 104 may be or include a file reader. The file redear (e.g., the parsing module 104) may ingest the raw data files included in the project data 102. The parsing module 104 determines different file types present in the project data 102 such as CSV, Excel, JSON, XML, text logs, proprietary formats, among others.

The parsing module 104 parses the file into a structured format, such as python objects, database tables, data frames, etc. In some embodiments, the parsing module 104 may clean the data by handling missing values, removing duplicates, and/or normalizing formats. For example, “10000 USD” may be converted to 10000 for consistent handling.

The parsing module 104 identifies the variables 106 (e.g., columns, attributes, features) that include project descriptors (e.g., ID, name, type, dates), resource variables (e.g., a budget, personnel, materials, specifications), performance variables (e.g., KPIs, test results, failures), environmental variables (e.g., temperature, load, stress factors), etc.

In some embodiments, each variable may be classified into a category of a set of categories. The set of categories may include categories related to the potential studies. Some examples of the categories may include engineering study variables (e.g., stress limits, material properties, load capacity, etc.), software study variables (e.g., response time, defect rate, throughput, etc.), business study variables (e.g., return on investment, budget variance, schedule delay, etc.), research and development (R&D) variables (e.g., experimental results, error margins, statistical significance). In some embodiments, the variables 106 may be stored in a central project repository. The central project repository may be a single, unified storage configured as a storage and source for different project-related data, documents, code, test results, resources, etc.

The study identification module 108 is configured to identify studies that may be applicable based at least on the variables 106. For example, the study identification module 108 generates identified studies 110. In some instances, the identified studies 110 include one or more studies that are applicable to the project associated with the project data 102. In some embodiments, the identified studies 110 may be selected from a list of available studies. In some instances, the list of available studies may be stored in the central project repository.

Additionally or alternatively, in some embodiments, the user may select certain studies to be included in the identified studies 110. For example, a project may have certain requirements based on contracts, industry standards, etc. In such instances, the user may specifically select one or more studies associated with the certain requirements.

In some embodiments, each study of the available studies may be associated with one or more variables. For example, a study related to safety of a product may be associated with variables such as material properties, load capacity, defect rate, etc.

In some embodiments, the studies module 112 may be configured to run the identified studies 110 based at least on the variables 106. In some embodiments, running the studies may include running one or more models corresponding to the studies. A model may refer to a representation of a system or a process under investigation, constructed such that the study can test hypotheses, run simulations, or evaluate scenarios without directly acting on the real-world system. As an example, a study may be related to investigating fault current magnitudes. The model associated with such a study may be an electrical network model with fault conditions.

In some embodiments, the models may be pre-built and stored. For example, the models associated with the available studies stored in the repository may be pre-built. The pre-built models may be labeled as being associated with the studies and stored in the central project repository. Additionally or alternatively, the models may be built based on the studies. For example, the models may be generated based on the study requirements. In some embodiments, at least one model may be selected or built for each study. For example, in instances the identified studies 110 include multiple studies, at least one model may be selected or built for each study included in the identified studies 110. For example, in instances the identified studies 110 include a first study and a second study. At least a first model corresponding to the first study and a second model corresponding to the second study may be selected or generated.

In some embodiments, multiple models may be selected and/or generated in a substantially parallel manner. For example, in instances the first model is being generated for the first study, and the second model is being generated for the second study, the first study and the second study may be generated substantially in parallel. Such parallel manners may help reduce the time taken to prepare the models for testing. For example, compared to traditional approaches in which the models are built and run in sequence, the parallel manner of building or generating the models and running the models may help improve the efficiency of the studies.

In some embodiments, the identified studies 110 may not be able to run due to missing variables. For example, a study may be associated with multiple variables. In some instances, the variables 106 may not include one or more variables that may be needed to run certain studies (via the corresponding models). In some embodiments, the studies may make assumptions with respect to the missing variable. For example, a certain utility information necessary to run a study may be missing. In such instances, an assumption may be made with respect to the missing variable and the study may be run pending the official value from the utility in question. The assumptions may help run the studies without possibly being stuck at a certain state.

The studies module 112 may generate studies output 114 based on the operations of the corresponding models. In some embodiments, the studies output 114 includes results, findings, and performance indicators produced when the identified studies 110 are executed on corresponding models. In some embodiments, the studies output 114 may be generated based on a standard format. For example, the studies output may include fillable portions and static portions. The fillable portions may include specific results of the studies, and the static portions include static text describing the results in the fillable portions. In other embodiments, the studies output 114 may be generated in a free format without a specific structure.

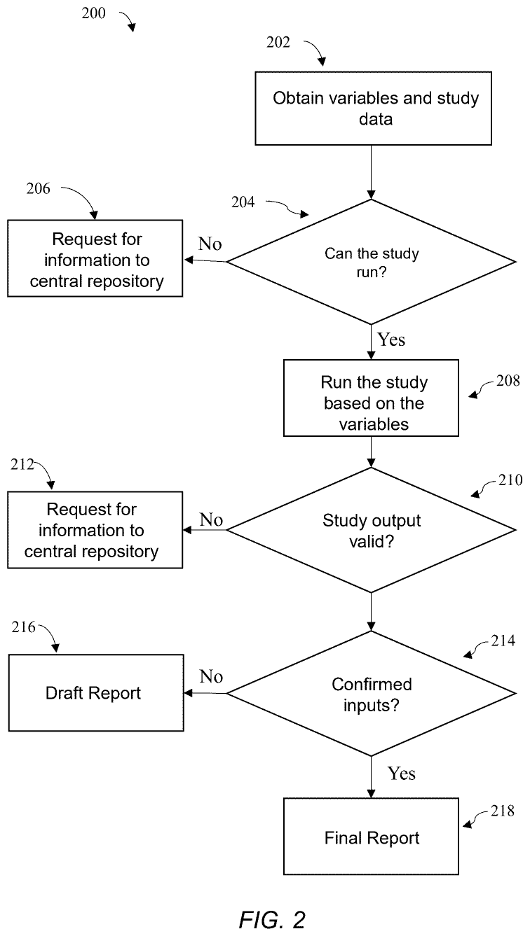

In some embodiments, the study running process may include one or more verification steps. For example, the variables 106, and the identified studies 110 may be analyzed to determine whether the studies can run properly. Additionally or alternatively, the studies output 114 may be verified. In some embodiments, the study running process may be described in further detail with respect to FIG. 2 of the present disclosure.

In some embodiments, the reporting module 116 may be configured to generate reports 118 based on the studies output 114. The reports 118 may be a structured document that summarizes the methods, models, results, and conclusions of the one or more studies performed. In some embodiments, a distinct report may be generated for each study performed. For example, a first report may be generated for the first study, and a second report may be generated for the second study. In some embodiments, the reports 118 may be stored in the file storage. The file storage may be the same storage storing the project data 102.

In some embodiments, the deliverable module 120 may be configured to generate a deliverable 122 including the reports 118. The deliverable 122 may refer to a tangible or intangible output produced as a part of a project. The deliverable 122 may be a package of the reports 118, including documented results of the studies based on the corresponding models. In some embodiments, the deliverable 122 may include different types of content. For example, the deliverable 122 may include an executive summary document (e.g., explains scope, objectives, and key findings of all included studies), individual study reports (e.g., the reports 118), supporting data and models, recommendations (e.g., recommended actions to follow the studies), etc.

In some embodiments, the deliverable module 120 may be configured to verify that all studies included in the deliverable 122 are final and complete. For example, the studies may not be final due to missing or insufficient information and/or variables. In such instances, a draft of the deliverable 122 may be generated for client feedback. For example, the draft deliverable may indicate the missing information for the client or the user to provide. Such new information may be processed using the parsing module 104 to identify the variables 106 to be used in the studies. In instances the studies are final, the deliverable 122 may be delivered to the user.

In some embodiments, the one or more operations of the system 100 may be monitored and/or reviewed by an operator (e.g., an engineer). In some embodiments, the operator may review the deliverable 122 prior to providing the deliverable 122 to the user. the operator may review to verify the accuracy and/or completeness of the deliverable 122. In some embodiments, the operator may review different parts prior to reaching the deliverable 122. For example, the operator may review the variables 106, the identified studies 110, the studies output 114 and/or the reports 118. In instances any outputs are incomplete or inaccurate, the operator may provide revisions or additional information.

In some embodiments, one or more operations may be caused to be performed based at least on the deliverable 122. In an example, the one or more operations may be determined based on the recommendations included in the deliverable 122. For example, the recommendations may include replacing a certain part, adjusting the specifications, etc.

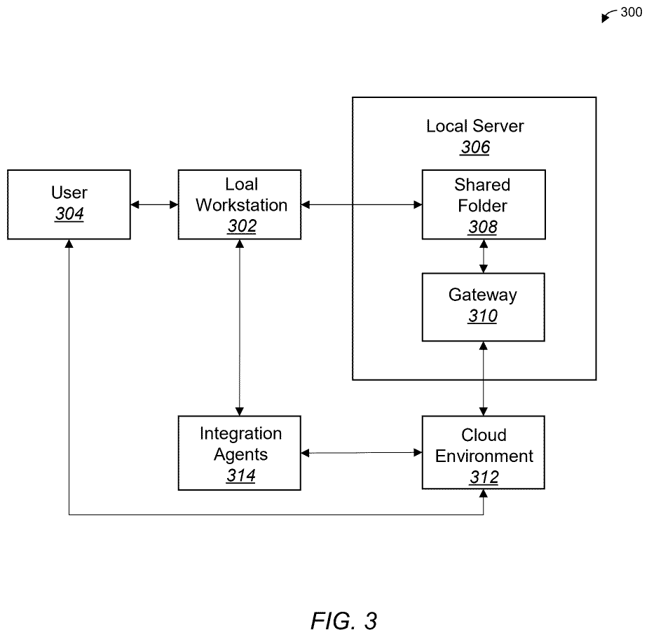

In some embodiments, at least a portion of the system 100 may be implemented on a cloud computing platform. For example, the system 100 may be perform at least a part of the processing, storage, and applications on remote servers provided a cloud service provider. For example, FIG. 3 illustrates an example cloud environment in which the system 100 may be implemented.

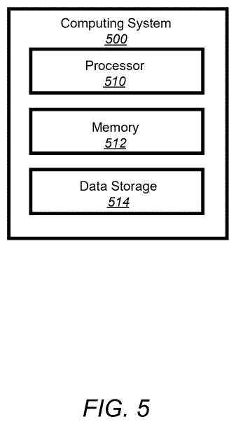

FIG. 2 illustrates a flowchart for a study testing method 200, in accordance with some embodiments of the present disclosure. The method 200 may be performed by any suitable system, apparatus, or device. For example, the method 200 may be implemented using the system 100 of FIG. 1 or the computing system 500 of FIG. 5. Although illustrated with discrete blocks, the steps and operations associated with one or more blocks of the method 200 may be divided into additional blocks, combined into fewer blocks, or eliminated, depending on the particular implementation. In some embodiments, the method 200 may describe some parts of the system 100 in more detail.

The method 200 may being at block 202. At block 202, variables and study data are obtained. The variables may be extracted from project data obtained from a user. The variables may represent key characteristics and/or aspects of the project associated with the project data. The variables may correspond to the variables 106 of FIG. 1, and the study data may correspond to the identified studies 110 of FIG. 1.

The studies may be identified from a set of available tests. Additionally or alternatively, the user may provide the studies. In some embodiments, the study data may be associated with one or more studies. For example, a first study and a second study may be associated with the variables. In some embodiments, the variables and the studies may be stored in a central project repository configured to store all project data associated with the system 100.

At block 204, it may be verified whether the study can run based on the variables. For example, a first study may be associated with a first set of variables. In some instances, the variables extracted from the project data may not include all the variables in the first set of variables. For example, the variables extracted from the project data may not include all the variables in the first set of variables.

In such instances, the method 200 may include requesting information for the missing variables to the central project repository at block 206. The central project repository may be configured to locate the missing variable in instances the missing variable is available. In instances the missing variable is not available in the central project repository, the user may be notified.

At block 208, in response to determining that the studies can run, the studies may be run based on the variables. For example, the variables may include the first set of variables associated with the first study and a second set of variables associated with the second study. In the present disclosure, a reference to running a study may include a reference to running one or more models associated with each study. For example, a first model associated with the first study may be run, and a second model associated with the second study may be run. In some embodiments, the models may be selected or obtained from the central project repository. Additionally or alternatively, the models may be generated based on the studies and the variable.

At block 210, the output of the studies may be verified. For example, the validity of the outputs may be verified. For example, it may be confirmed that the results produced by the studies or the models corresponding to the studies are accurate, reliable, and aligned with real-world conditions, standards, or expectations. For example, data used in the models may be verified to be correct, complete, and relevant. For example, the studies can run if all the variables are present, but the outputs may be verified to confirm that the variables represent accurate data. In some embodiments, the study output may correspond to the studies output 114 of FIG. 1.

Additionally or alternatively, the validity of the models may be verified. For example, the models may be analyzed to determine whether the model reflects reality sufficiently for the purpose of the study. In some embodiments, the studies may be analyzed to determine whether the studies followed recognized standards, codes, or scientific methods. For example, studies related to circuits may be analyzed with respect to IEEE (Institute of Electrical and Electronics Engineers) standards. In some embodiments, any other suitable methods of verification may be used. In some embodiments, the verification may be performed by a human reviewer, such as an engineer. Additionally or alternatively, the review may be performed by an automated process.

In instances the study output is not valid, a request for information may be sent to the central project repository at block 212. The issues with the study that caused the invalidity of the output may be determined, such as inaccurate or inappropriate models, inaccurate data, etc. The identified issues may be sent to the central project repository such that the new or revised data or models may be obtained to address the issues.

In instances the study output is valid, at block 214, the inputs may be confirmed. Confirming the inputs may refer to confirming that the data, parameters, and assumptions fed into the models were correct, consistent, and traceable. For example, even in instances the study output appears valid, the study output may still be based on wrong or outdates inputs. Confirming the inputs may help validate that the outputs were produced under the right conditions, the study is reproducible, and that there is a clear audit trail between input, mode, study, and output.

In some embodiments, the process for confirming the inputs may include input source verification (e.g., trace back to the original data source, such as the project data 102 of FIG. 1), input completeness check (confirm all required inputs for the study were included), input accuracy (e.g., confirm numerical entries for typos or unit mismatches), input consistency (e.g., cross-verify related inputs), version and revision control (e.g., record the version of data used), stakeholder confirmation (e.g., have domain experts, such as human reviewer or engineer, confirm that the chose inputs are realistic and acceptable), etc.

In instances the inputs are not confirmed, at block 216, a draft report may be generated at 216. The draft report may document the study process and preliminary results, even though inputs could not be confirmed. The draft report may highlight risk, uncertainties, and/or data gaps that prevent issuing a final report. The draft report may provide the stakeholders with enough information to decide whether to supply missing or incorrect inputs, revise assumptions, and/or defer or cancel the study.

In instances the inputs are confirmed, at block 218, a final draft may be generated. The final report may provide authoritative and approved study results. The final report may include study objectives, scope, and methodology. The inputs may have verified and traceable data sources. The final report may further include conclusions and/or recommendations based on the validated inputs. In some embodiments, the final report may correspond to the reports 118 of FIG. 1.

FIG. 3 illustrates an operating environment 300, in accordance with some embodiments of the present disclosure. The operating environment 300 may illustrate an environment in which the system 100 of FIG. 1 operates. For example, the operations described with respect to FIGS. 1-2 may be performed in the operating environment 300.

In some embodiments, the operating environment 300 may include a local workstation 302, a local server 306, a cloud environment 312 and integration agents 314. The local workstation may represent an access point for a user 304. The local workstation 302 may be configured to communicate with the local server 306 for internal resources via shared folder 308. The local workstation 302 may further communicate with integration agents 314 for connecting with external and cloud resources.

The local server 306 may represent internal on-premises server configured to host the shard folder 308 and a gateway 310. The shared folder 308 is a storage location accessible within the organization. For example, the shared folder 308 may be a file storage as discussed in FIG. 1. For example, the shared folder 308 may store at least some studies and/or models. The gateway 310 is a bridge configured to link the local infrastructure with the cloud environment 312.

The cloud environment 312 may be an external cloud-based system. The cloud environment 312 is a virtualized computing infrastructure provided by a third-party service provider, where computing resources, storage, networking, and applications are delivered on-demand over the internet. The computing processes caused by the user 304 may be computed within the cloud environment 312 instead of the local workstation 302. For example, operations such as running studies, models, storing data, and/or generating reports may be performed within the cloud environment 312.

As an example, the cloud environment 312 may be provided by Amazon Web Servies (AWS). In these and other embodiments, the local server may include an AWS storage gateway. The AWS storage gateway may be configured to connect the local workstations to clouds-based storage (e.g., in AWS). The AWS storage gateway may allow the system to integrate on-premises applications and data (e.g., stored in the local storage) with cloud storage, enabling hybrid cloud architectures. For example, the AWS storage gateway may allow the system to use the AWS environment to perform one or more operations with respect to the input data. While described with respect to AWS, the system 100 may be implemented using any other suitable cloud computing platforms.

In some embodiments, the integration agents 314 represent the middleware components that connect the local workstation 302 with the cloud environment 312. The functions of the integration agents 314 may include data exchange and synchronization, protocol and format translation, automation of workflows, security and access control, and/or monitoring and logging, among others. The integration agents 314 may be installed on the local workstation 302, within the cloud environment 312, or both.

Modifications, additions, or omissions may be made to the operating environment 300 without departing from the scope of the present disclosure. For example, the outlined steps and operations are only provided as examples, and some of the steps and operations may be optional, combined into fewer steps and operations, or expanded into additional steps and operations without detracting from the essence of the disclosed embodiments.

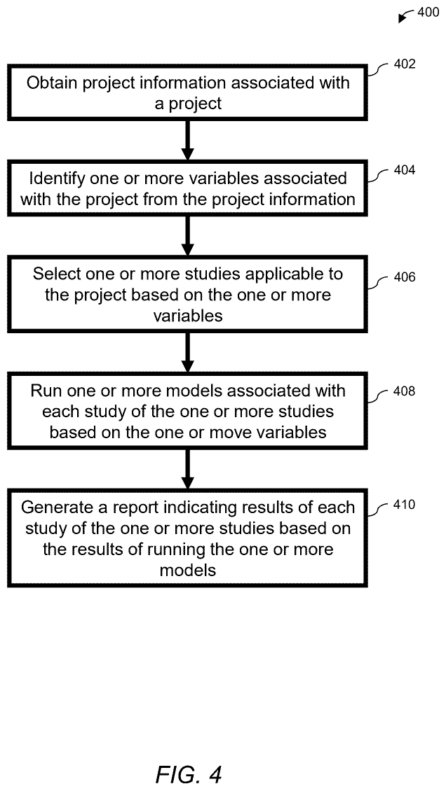

FIG. 4 is a flowchart of an example method 400 for centralized data management and testing, arranged in accordance with one or more embodiments of the present disclosure. One or more operations of the method 400 may be implemented by any suitable system such as the system 100 of FIG. 1 and/or the computing system 500 of FIG. 5. In some embodiments, the method 400 may be implemented using a cloud environment, such as illustrated in FIG. 3. Although illustrated as discrete steps, various steps of the method 400 may be divided into additional steps, combined into fewer steps, or eliminated, depending on the desired implementation. Additionally, the order of performance of the different steps may vary depending on the desired implementation.

In some embodiments, the method 400 may begin at block 402. At block 402, project information associated with a project may be obtained. For example, the project information may be obtained from a user associated with the project. In some embodiments, the project information may include information needed to set up the project such as project location, project type, specifications of different components and/or parts, and project requirements, and other information needed to set up a project. In some embodiments, the project information may correspond to the project data 102 of FIG. 1.

At block 404, one or more variables associated with the project may be identified from the project information. In some embodiments, the one or more variables may correspond to key terms, definitions, and/or specifications that may be used to define specifics of the project. For example, the variables may include particular specification of a part, different measurements, requirements, among others. In some embodiments, the variables may correspond to the variables 106 of FIG. 1.

At block 406, one or more studies (e.g., the identified studies 110 of FIG. 1) applicable to the project may be selected based on the one or more variables. Each study of the one or more studies may study and/or analyze certain aspects of the project. Each study may be associated with a set of variables that are applicable. Based on the one or more variables identified from the project information, applicable studies that are associated with the identified variables may be selected for the project.

At block 408, one or more models may be run using the one or more variables. For example, the one or more variables may fill in the blank spots of applicable models. In some embodiments, a particular variable may be applicable to a plurality of models. In such instances, the particular variable may be used to fill in a plurality of blank spots. The completed models may be run, such that the corresponding studies may be run with respect to the variables. In some embodiments, the models may be selected from existing set of available studies. For example, the one or more models may be pre-generated. For example, the models corresponding to different studies may be pre-designed and stored, such that the models may be used with project-specific variables.

Additionally or alternatively, the one or more models corresponding to the one or more studies may be generated. In some embodiments, the models may be configured to run the studies for the project using the one or more studies particular to the project. In some embodiments, the models may be built and/or generated in response to determining the one or more studies from the one or more variables. In some embodiments, the one or more models may include blank spots corresponding to different variables. For example, the variables may complete the one or more models with project-specific data.

At block 410, a report indicating results of the one or more studies may be generated. In some embodiments, separate reports may be generated for each study. In some embodiments, a report including results from the one or more studies and/or models may be generated.

Modifications, additions, or omissions may be made to the method 400 without departing from the scope of the present disclosure. For example, the outlined steps and operations are only provided as examples, and some of the steps and operations may be optional, combined into fewer steps and operations, or expanded into additional steps and operations without detracting from the essence of the disclosed embodiments.

For example, the method may further include obtaining additional information associated with the project. For example, the additional information may include changes made to the previously obtained project information and/or additional information. For example, a part and/or specification included in the project information may be changed. As another example, a new part and/or requirement may be added.

In some embodiments, updated and/or new variables may be identified from the additional information. For example, previously identified variables may be updated and/or changed, and/or new variables that were previously not identified may be identified. In these and other embodiments, the identified updated variables may be used to update the variables in the one or more models. For example, a first variable may have been previously used in a first model and a second model. In response to identifying a change to the first variable in the additional information, the first model and the second model be consequently updated to include the change to the first variable. In some embodiments, the one or more models may be updated using the updated variables may be performed in a substantially parallel manner. For example, the one or more models including the updated variables may be identified and updated substantially simultaneously.

In some embodiments, in instances in which new variables are identified in the updated information, additional studies may be determined as applicable. In these and other embodiments, one or more additional models corresponding to the additional studies may be identified and/or generated. In some embodiments, the additional information may include changes in which certain variables are no longer present. In these and other embodiments, certain studies that may be associated with the certain variables that are no longer present may be identified and removed. In some embodiments, only a subset of the variables applicable to a particular study may be no longer present. In such instances, the particular study may be run without the subset of the variables in instances in which the certain variables are not essential. For example, in some embodiments, the studies may be associated with one or more essential variables which are needed for the studies to run. In instances in which there is not enough variables to select and/or run the one or more studies, missing and/or needed variables may be identified. In some embodiments, the user may be notified of the missing variables such that the missing variables may be provided.

In some embodiments, the one or more models and the one or more additional models may be run using the updated variables. In some embodiments, all the models may be run again. In some embodiments, only the models corresponding to the studies that include updated variables may be run again. In some embodiments, a second report may be generated including results of the one or more models and the additional models.

In some embodiments, the method 400 may include different verification processes. For example, a first verification process may verify the one or more studies identified from the one or more variables, and a second verification process may verify the results of the one or more models. In some embodiments, the verification processes may be performed by a human operator, such as the engineer of record and/or a quality assurance personnel.

FIG. 5 illustrates a block diagram of an example computing system 500 that may be used with respect a data management system, according to at least one embodiment of the present disclosure.

The computing system 500 may include a processor 510, a memory 512, and a data storage 514. The processor 510, the memory 512, and the data storage 514 may be communicatively coupled.

In general, the processor 510 may include any suitable special-purpose or general-purpose computer, computing entity, or processing device including various computer hardware or software modules and may be configured to execute instructions stored on any applicable computer-readable storage media. For example, the processor 510 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 5, the processor 510 may include any number of processors configured to, individually or collectively, perform or direct performance of any number of operations described in the present disclosure. Additionally, one or more of the processors may be present on one or more different electronic devices, such as different servers.

In some embodiments, the processor 510 may be configured to interpret and/or execute program instructions and/or process data stored in the memory 512, the data storage 514, or the memory 512 and the data storage 514. In some embodiments, the processor 510 may fetch program instructions from the data storage 514 and load the program instructions in the memory 512. After the program instructions are loaded into memory 512, the processor 510 may execute the program instructions.

The memory 512 and the data storage 514 may include computer-readable storage media for carrying or having computer-executable instructions or data structures stored thereon. Such computer-readable storage media may include any available media that may be accessed by a general-purpose or special-purpose computer, such as the processor 510. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 510 to perform a certain operation or group of operations.

Modifications, additions, or omissions may be made to the computing system 500 without departing from the scope of the present disclosure. For example, in some embodiments, the computing system 500 may include any number of other components that may not be explicitly illustrated or described.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Additionally, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B” even if the term “and/or” is used elsewhere.

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

1. A method comprising:
obtaining project information associated with a project,
identifying one or more variables associated with the project based on the project information;
selecting one or more studies applicable to the project based on the one or more variables;
running one or more models associated with each study of the one or more studies based on the one or more variables; and
generating a report including results of each study of the one or more studies based on the results of running the one or more models.

2. The method of claim 1, further comprising:
obtaining additional information associated with the project;
identifying updated variables from the additional information;
updating the one or more models using the updated variables;
running the one or more models using the updated variables; and
generating a second report.

3. The method of claim 2, further comprising:
identifying one or more additional studies based on the updated variables;
generating one or more additional models corresponding to the one or more additional studies; and
running the one or more additional models using the updated variables.

4. The method of claim 1, wherein the report is validated by a human operator.

5. The method of claim 1, wherein the one or more models are run substantially parallel.

6. The method of claim 1, wherein the one or more models are selected from available models or generated based on the one or more studies.

7. The method of claim 1, further comprising:
determining that the one or more variables are sufficient to select the one or more studies.

8. The method of claim 7, further comprising:
in response to determining that the one or more variables are not sufficient, determining one or more missing variables needed to select the one or more studies.

9. The method of claim 1, wherein the method is implemented on a cloud environment.

10. One or more non-transitory computer-readable media storing instructions that, when executed by one or more processors, cause a system to perform operations, the operations comprising:
obtaining project information associated with a project,
identifying one or more variables associated with the project based on the project information;
selecting one or more studies applicable to the project based on the one or more variables;
running one or more models associated each study of the one or more studies based on the one or more variables; and
generating a report including results of each study of the one or more studies based on the results of running the one or more models.

11. The one or more non-transitory computer-readable media of claim 10, the operations further comprising:
obtaining additional information associated with the project;
identifying updated variables from the additional information;
updating the one or more models using the updated variables;
running the one or more models using the updated variables; and
generating a second report.

12. The one or more non-transitory computer-readable media of claim 11, the operations further comprising:
identifying one or more additional studies based on the updated variables;
generating one or more additional models corresponding to the one or more additional studies; and
running the one or more additional models using the updated variables.

13. The one or more non-transitory computer-readable media of claim 10, wherein the report is validated by a human operator.

14. The one or more non-transitory computer-readable media of claim 10, wherein the one or more models are run substantially parallel.

15. The one or more non-transitory computer-readable media of claim 10, wherein the one or more models are selected from available models or generated based on the one or more studies.

16. The one or more non-transitory computer-readable media of claim 10, the operations further comprising:
determining that the one or more variables are sufficient to select the one or more studies.

17. The one or more non-transitory computer-readable media of claim 16, the operations further comprising:
in response to determining that the one or more variables are not sufficient, determining one or more missing variables needed to select the one or more studies.

18. The one or more non-transitory computer-readable media of claim 10, wherein the operations are implemented in a cloud environment.

19. A system, comprising:
one or more processors; and
one or more non-transitory computer-readable storage media configured to store instructions that, in response to being executed, cause the system to perform operations, the operations comprising:
obtaining project information associated with a project,
identifying one or more variables associated with the project based on the project information;
selecting one or more studies applicable to the project based on the one or more variables;
running one or more models associated each study of the one or more studies based on the one or more variables; and
generating a report including results of each study of the one or more studies based on the results of running the one or more models.

20. The system of claim 19, wherein the one or more models are run substantially parallel.
